(19) United States
(12) Patent Application Publication
(10) Pub. No.: US 2009/0062439 A1
(43) Pub. Date: Mar. 5, 2009

(54) POLYESTERCARBONATE COMPOSITIONS

(76) Inventors: Robert Dirk van de Grampel, Het Lint (NL); Theodorus Lambertus Hoeks, Halsterseweg (NL); Jan-Pleun Lens, Kanarlestraat (NL); Dake Shen, Shanghai (CN); Rajendra Kashinath Singh, Evansville, IN (US)

Correspondence Address: SABIC - LEXAN;SABIC Innovative Plastics - IP Legal, ONE PLASTICS AVE., PITTSFIELD, MA, 01201-3697, US

(21) Appl. No.: 11/847,722

(22) Filed: Aug. 30, 2007

(51) Int. Cl. C08G 64/04; C08K 5/42

(52) U.S. Cl. 524/165; 524/604

(57) ABSTRACT

A fire-resistant polyestercarbonate composition comprises a polyestercarbonate polymer, a polycarbonate polymer, and a salt based flame retardant. The polyestercarbonate polymer comprises a polycarbonate unit and a polyester unit, the polyester unit derived from the reaction of isophthalic acid, terephthalic acid, and resorcinol. The composition can achieve UL94 V0 performance at 0.71 mm thickness. The composition can also maintain physical, mechanical, and processing properties with high loadings of TiO₂.

### BACKGROUND

The present disclosure relates to fire-resistant polyestercarbonate compositions. Also disclosed herein are methods for preparing and/or using the same.

Polycarbonates are synthetic thermoplastic resins derived from bisphenols and phosgenes, or their derivatives. They are linear polyesters of carbonic acid and can be formed from dihydroxy compounds and carbonate diesters, or by ester interchange. Polymerization may be in aqueous, interfacial, or in nonaqueous solution.

Polycarbonates are a very useful class of polymers. They have many properties and/or characteristics that are desired in certain instances. These include optical clarity or transparency (i.e. 90% light transmission or more), high impact strength (i.e. good impact resistance), beneficial heat resistance, weather and ozone resistance, relatively low density, good ductility, favorable electrical resistance, noncorrosive, nontoxic, etc.

Furthermore, polycarbonates can be readily used in various article formation processes, such as molding (injection molding, etc.), extrusion, and thermoforming, among others. As a result, polycarbonates are used frequently to form a wide variety of products and packaging including: molded products, solution-cast or extruded films, structural parts, tubes and piping, windows, lenses, safety shields, aircraft canopies, instrument windows, automotive headlamps and components, and medical devices and healthcare related products. Household articles formed from polycarbonates can be produced in a great variety of colors and can be painted, glued, planed, pressed, and metalized and can be used to form precision parts, appliances, power tools, and electronic products, among others.

However, polycarbonate resins are inherently flammable. They can also drip hot molten material, causing nearby materials to catch fire as well. It is thus typically necessary to include fire retardant additives that retard the flammability of the polycarbonate resin and/or reduce dripping. Known additives include various sulfonic acid salts, phosphates, and halogenated flame retardants. However, phosphates generally need to be used at higher concentrations (5-10%) to achieve the same performance as sulfonic acid salts. Halogenated flame retardants, on the other hand, may release toxic gases when heated to elevated temperatures.

There is a continuing demand for polycarbonates which maintain their fire resistance and other properties at thinner gauges. Generally, as the gauge decreases, fire resistance decreases as well. Furthermore, it would be beneficial to have a polycarbonate composition which has good processability and mechanical properties.

There is also a demand for white polycarbonate compositions. Whiteness is usually achieved by the use of colorants such as titanium dioxide (TiO₂). However, high loadings of TiO₂ are generally required. As the colorant or TiO₂ loading increases, the flow rate and/or mechanical properties of the polycarbonate decrease as well.

Additionally, there is a continued need for polyestercarbonate compositions which are fire or flame resistant, such as at thinner gauges, while maintaining other desired mechanical or processing properties of polycarbonates.

### Brief Description

Disclosed, in various embodiments, are polyestercarbonate compositions and processes for making and using them. The polyestercarbonate compositions are able to attain UL94 V0 ratings at very thin wall molded thicknesses, such as at 0.71 millimeter thickness.

In embodiments, a fire-resistant polyestercarbonate composition is disclosed which comprises:
a salt based flame retardant; a polycarbonate polymer comprising at least one monomer; and
a polyestercarbonate polymer comprising a polycarbonate unit and a polyester unit, the polyester unit derived from the reaction of isophthalic acid, terephthalic acid, and resorcinol, and represented by the structure of Formula (IV):

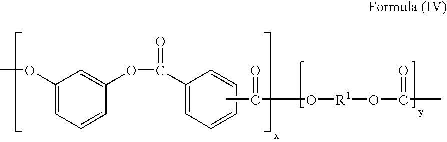

where x is the molar percentage of the polyester unit and y is the molar percentage of the polycarbonate unit, x and y adding up to 100 mole percent of the polyestercarbonate polymer;
wherein the polycarbonate polymer differs from the polyestercarbonate polymer;
wherein the composition contains at least 8 mole percent of polyester units, based on the total moles of the at least one monomer, polycarbonate unit, and polyester unit; and
wherein the polyestercarbonate polymer contains at least 40 mole percent of the polyester unit, based on the total moles of polycarbonate units and polyester units.

The polyestercarbonate polymer may contain at least 12 mole percent of the polyester unit.

The weight ratio of polyestercarbonate polymer to polycarbonate polymer may be from about 14:86 to about 90:10.

The polycarbonate polymer may be a polycarbonate homopolymer.

The salt based flame retardant may be a Na, K, or Li perfluorobutane sulfonate. The salt based flame retardant may be present in the amount of from about 0.05 parts to about 0.15 parts per hundred parts resin.

The composition may have a melt volume rate of from about 5 cc/10 minutes to about 25 cc/10 minutes, according to ASTM D1238. The composition may have a notched Izod impact of from about 200 J/m to about 800 J/m, according to ASTM D256. The composition may have a heat deflection temperature of at least 114° C., according to ASTM D648, and in further embodiments has a heat deflection temperature of from 114° C. to 1 20° C.

The composition may further comprise an anti-drip agent. The anti-drip agent may be present in the amount of about 0.1 to about 5 parts per hundred parts resin.

The composition may further comprise a colorant. The colorant may be present in the amount of zero to about 12 parts per hundred parts resin. The colorant may be titanium dioxide (TiO₂).

In other embodiments, a fire-resistant polyestercarbonate composition is disclosed comprising:
a salt based flame retardant;
an anti-drip agent;
a polycarbonate polymer comprising at least one monomer; and
a polyestercarbonate polymer comprising a polycarbonate unit and a polyester unit, the polyester unit derived from the reaction of isophthalic acid, terephthalic acid, and resorcinol, and represented by the structure of Formula (IV):

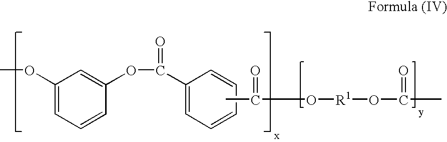

where x is the molar percentage of the polyester unit and y is the molar percentage of the polycarbonate unit, x and y adding up to 100 mole percent of the polyestercarbonate polymer;
wherein the polycarbonate polymer differs from the polyestercarbonate polymer;
wherein the composition contains at least 8 mole percent of polyester units, based on the total moles of the at least one monomer, polycarbonate unit, and polyester unit; and
wherein the polyestercarbonate polymer contains at least 75 mole percent of the polyester unit, based on the total moles of polycarbonate units and polyester units.

In other embodiments, a fire-resistant polyestercarbonate composition is disclosed comprising:
a salt based flame retardant;
an anti-drip agent;
a polyestercarbonate polymer comprising a polycarbonate unit and a polyester unit, the polyester unit derived from the reaction of isophthalic acid, terephthalic acid, and resorcinol, and represented by the structure of Formula (IV):

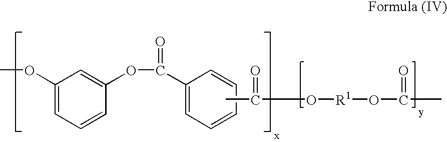

where x is the molar percentage of the polyester unit and y is the molar percentage of the polycarbonate unit, x and y adding up to 100 mole percent of the polyestercarbonate polymer; and
a polycarbonate homopolymer comprising at least one monomer;
wherein the composition contains at least 12 mole percent of polyester units, based on the total moles of the at least one monomer, polycarbonate unit, and polyester unit;
wherein the polyestercarbonate polymer contains at least 75 mole percent of the polyester unit, based on the total moles of the polyestercarbonate polymer; and
wherein the weight ratio of polyestercarbonate polymer to polycarbonate homopolymer is from about 14:86 to about 90:10.

These and other non-limiting characteristics are more particularly described below.

### DETAILED DESCRIPTION

Numerical values in the specification and claims of this application, particularly as they relate to polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

As used herein, “polycarbonate” refers to an oligomer or polymer comprising residues of one or more dihydroxy compounds joined by carbonate linkages.

The term “polyestercarbonate polymer” refers to a copolymer formed from a polycarbonate unit and a polyester unit.

The fire-resistant composition comprises a polycarbonate polymer and a polyestercarbonate polymer, the polyestercarbonate polymer comprising a polycarbonate unit and a polyester unit. The polycarbonate polymer and the polycarbonate unit may be a repeating structural carbonate unit of the formula (1):

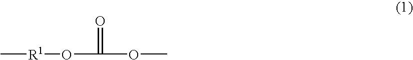

in which at least 60 percent of the total number of R¹ groups are aromatic organic radicals and the balance thereof are aliphatic, alicyclic, or aromatic radicals. In one embodiment, each R¹ is an aromatic organic radical, for example a radical of the formula (2):

-A¹-Y¹-A² (2)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O)₂—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, which includes dihydroxy compounds of formula (3)

HO-A¹-Y¹-A²-OH (3)

wherein Y¹, A¹ and A² are as described above. Also included are bisphenol compounds of general formula (4):

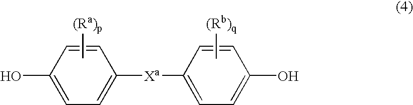

wherein R^{a} and R^{b} each represent a halogen atom or a monovalent hydrocarbon group and may be the same or different; p and q are each independently integers of 0 to 4; and X^{a} represents one of the groups of formula (5):

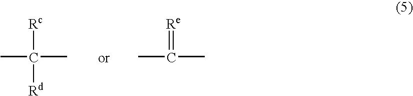

wherein R^{c} and R^{d} each independently represent a hydrogen atom or a monovalent linear or cyclic hydrocarbon group and R^{e} is a divalent hydrocarbon group.

In an embodiment, a heteroatom-containing cyclic alkylidene group comprises at least one heteroatom with a valency of 2 or greater, and at least two carbon atoms. Heteroatoms for use in the heteroatom-containing cyclic alkylidene group include —O—, —S—, and —N(Z)—, where Z is a substituent group selected from hydrogen, hydroxy, C₁₋₁₂ alkyl, C₁₋₁₂ alkoxy, or C₁₋₁₂ acyl. Where present, the cyclic alkylidene group or heteroatom-containing cyclic alkylidene group may have 3 to 20 atoms, and may be a single saturated or unsaturated ring, or fused polycyclic ring system wherein the fused rings are saturated, unsaturated, or aromatic.

Other bisphenols containing substituted or unsubstituted cyclohexane units can be used, for example bisphenols of formula (6):

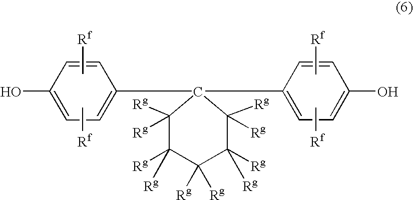

wherein each R^{f} is independently hydrogen, C₁₋₁₂ alkyl, or halogen; and each R^{g} is independently hydrogen or C₁₋₁₂ alkyl. The substituents may be aliphatic or aromatic, straight chain, cyclic, bicyclic, branched, saturated, or unsaturated. Such cyclohexane-containing bisphenols, for example the reaction product of two moles of a phenol with one mole of a hydrogenated isophorone, are useful for making polycarbonate polymers with high glass transition temperatures and high heat distortion temperatures. Cyclohexyl bisphenol containing polycarbonates, or a combination comprising at least one of the foregoing with other bisphenol polycarbonates, are supplied by Bayer Co. under the APEC® trade name.

Other useful dihydroxy compounds having the formula HO—R¹—OH include aromatic dihydroxy compounds of formula (7):

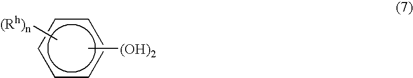

wherein each R^{h} is independently a halogen atom, a C₁₋₁₀ hydrocarbyl such as a C₁₋₁₀ alkyl group, a halogen substituted C₁₋₁₀ hydrocarbyl such as a halogen-substituted C₁₋₁₀ alkyl group, and n is 0 to 4. The halogen is usually bromine.

The polycarbonate polymer may be selected from homopolycarbonates, copolymers comprising different R¹ moieties in the carbonate (referred to herein as “copolycarbonates”), copolymers comprising carbonate units and other types of polymer units, such as ester units, polysiloxane units, and combinations comprising at least one of homopolycarbonates and copolycarbonates. As used herein, “combination” is inclusive of blends, mixtures, alloys, reaction products, and the like. A specific type of copolymer is a polyester carbonate, also known as a polyester-polycarbonate. Such copolymers further contain, in addition to recurring carbonate chain units of the formula (1), repeating units of formula (8):

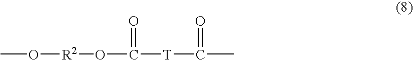

wherein R² is a divalent group derived from a dihydroxy compound, and may be, for example, a C₂₋₁₀ alkylene group, a C₆₋₂₀ alicyclic group, a C₆₋₂₀ aromatic group or a polyoxyalkylene group in which the alkylene groups contain 2 to about 6 carbon atoms, specifically 2, 3, or 4 carbon atoms; and T divalent group derived from a dicarboxylic acid, and may be, for example, a C₂₋₁₀ alkylene group, a C₆₋₂₀ alicyclic group, a C₆₋₂₀ alkyl aromatic group, or a C₆₋₂₀ aromatic group.

In an embodiment, R² is a C₂₋₃₀ alkylene group having a straight chain, branched chain, or cyclic (including polycyclic) structure. In another embodiment, R² is derived from an aromatic dihydroxy compound of formula (4) above. In another embodiment, R² is derived from an aromatic dihydroxy compound of formula (7) above.

Examples of aromatic dicarboxylic acids that may be used to prepare the polyester units include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or combinations thereof. A specific dicarboxylic acid comprises a combination of isophthalic acid and terephthalic acid wherein the weight ratio of isophthalic acid to terephthalic acid is about 91:9 to about 2:98. In another specific embodiment, R² is a C₂₋₆ alkylene group and T is p-phenylene, m-phenylene, naphthalene, a divalent cycloaliphatic group, or a combination thereof. This class of polyester includes the poly(alkylene terephthalates).

Polycarbonates can be manufactured by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like.

Carbonate precursors include, for example, a carbonyl halide such as carbonyl bromide or carbonyl chloride, or a haloformate such as a bishaloformates of a dihydric phenol (e.g., the bischloroformates of bisphenol-A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used. In an exemplary embodiment, an interfacial polymerization reaction to form carbonate linkages uses phosgene as a carbonate precursor, and is referred to as a phosgenation reaction.

Among the phase transfer catalysts that may be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Useful phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst may be about 0.1% by weight to about 10% by weight based on the weight of bisphenol in the phosgenation mixture. In another embodiment an effective amount of phase transfer catalyst may be about 0.5% by weight to about 2% by weight based on the weight of bisphenol in the phosgenation mixture.

Branched polycarbonate blocks may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha, alpha-dimethyl benzyl)phenol), 4-chloroformyl phthalic anhydride, trimesic acid, and benzophenone tetracarboxylic acid. The branching agents may be added at a level of about 0.05% by weight to about 2.0% by weight. Mixtures comprising linear polycarbonates and branched polycarbonates may be used.

In addition to the polycarbonates described above, combinations of the polycarbonate with other thermoplastic polymers, for example combinations of homopolycarbonates and/or polycarbonate copolymers with polyesters, may be used. Useful polyesters may include, for example, polyesters having repeating units of formula (8), which include poly(alkylene dicarboxylates), liquid crystalline polyesters, and polyester copolymers. The polyesters described herein are generally completely miscible with the polycarbonates when blended.

The polyesters may be obtained by interfacial polymerization or melt-process condensation as described above, by solution phase condensation, or by transesterification polymerization wherein, for example, a dialkyl ester such as dimethyl terephthalate may be transesterified with ethylene glycol using acid catalysis, to generate poly(ethylene terephthalate). It is possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

Useful polyesters may include aromatic polyesters, poly(alkylene esters) including poly(alkylene arylates), and poly(cycloalkylene diesters). Aromatic polyesters may have a polyester structure according to formula (8), wherein D and T are each aromatic groups as described hereinabove. In an embodiment, useful aromatic polyesters may include, for example, poly(isophthalate-terephthalate-resorcinol)esters, poly(isophthalate-terephthalate-bisphenol-A)esters, poly[(isophthalate-terephthalate-resorcinol)ester-co(isophthalate-terephthalate-bisphenol-A)]ester, or a combination comprising at least one of these. Also contemplated are aromatic polyesters with a minor amount, e.g., about 0.5% by weight to about 10% by weight, based on the total weight of the polyester, of units derived from an aliphatic diacid and/or an aliphatic polyol to make copolyesters. Poly(alkylene arylates) may have a polyester structure according to formula (8), wherein T comprises groups derived from aromatic dicarboxylates, cycloaliphatic dicarboxylic acids, or derivatives thereof. Examples of specifically useful T groups include 1,2-, 1,3-, and 1,4-phenylene; 1,4- and 1,5-naphthylenes; cis- or trans-1,4-cyclohexylene; and the like. Specifically, where T is 1,4-phenylene, the poly(alkylene arylate) is a poly(alkylene terephthalate). In addition, for poly(alkylene arylate), specifically useful alkylene groups D include, for example, ethylene, 1,4-butylene, and bis-(alkylene-disubstituted cyclohexane) including cis- and/or trans-1,4-(cyclohexylene)dimethylene. Examples of poly(alkylene terephthalates) include poly(ethylene terephthalate) (PET), poly(1,4-butylene terephthalate) (PBT), and poly(propylene terephthalate) (PPT). Also useful are poly(alkylene naphthoates), such as poly(ethylene naphthanoate) (PEN), and poly(butylene naphthanoate) (PBN). A useful poly(cycloalkylene diester) is poly(cyclohexanedimethylene terephthalate) (PCT). Combinations comprising at least one of the foregoing polyesters may also be used.

Copolymers comprising alkylene terephthalate repeating ester units with other ester groups may also be useful. Useful ester units may include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s may also include poly(alkylene cyclohexanedicarboxylate)s. Of these, a specific example is poly(1,4-cyclohexanedimethanol-1,4-cyclohexanedicarboxylate) (PCCD), having recurring units of formula (9):

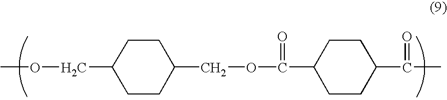

wherein, as described using formula (8), R² is a 1,4-cyclohexanedimethylene group derived from 1,4-cyclohexanedimethanol, and T is a cyclohexane ring derived from cyclohexanedicarboxylate or a chemical equivalent thereof, and may comprise the cis-isomer, the trans-isomer, or a combination comprising at least one of the foregoing isomers.

The polycarbonate polymer may be a polysiloxane-polycarbonate copolymer, also referred to as a polysiloxane-polycarbonate. The polysiloxane (also referred to herein as “polydiorganosiloxane”) blocks of the copolymer comprise repeating siloxane units (also referred to herein as “diorganosiloxane units”) of formula (10):

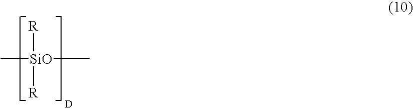

wherein each occurrence of R is same or different, and is a C₁₋₁₃ monovalent organic radical. For example, R may independently be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ arylalkyl group, C₇-C₁₃ arylalkoxy group, C₇-C₁₃ alkylaryl group, or C₇-C₁₃ alkylaryloxy group. The foregoing groups may be fully or partially halogenated with fluorine, chlorine, bromine, or iodine, or a combination thereof. Combinations of the foregoing R groups may be used in the same copolymer.

The value of D in formula (10) may vary widely depending on the type and relative amount of each component in the polymer, the desired properties of the polymer, and like considerations. Generally, D may have an average value of 2 to 1,000, specifically 2 to 500, and more specifically 5 to 100. In one embodiment, D has an average value of 10 to 75, and in still another embodiment, D has an average value of 40 to 60.

A combination of a first and a second (or more) polysiloxane-polycarbonate copolymer may be used, wherein the average value of D of the first copolymer is less than the average value of D of the second copolymer.

In one embodiment, the polydiorganosiloxane blocks are provided by repeating structural units of formula (11):

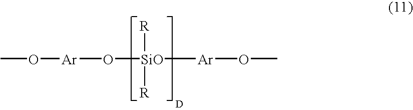

wherein D is as defined above; each R may independently be the same or different, and is as defined above; and each Ar may independently be the same or different, and is a substituted or unsubstituted C₆-C₃₀ arylene radical, wherein the bonds are directly connected to an aromatic moiety. Useful Ar groups in formula (11) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used. Specific examples of dihydroxyarylene compounds are 1,1-bis(4-hydroxyphenyl)methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxyphenyl)cyclohexane, bis(4-hydroxyphenyl sulphide), and 1,1-bis(4-hydroxy-t-butylphenyl)propane. Combinations comprising at least one of the foregoing dihydroxy compounds may also be used.

Units of formula (11) may be derived from the corresponding dihydroxy compound of formula (12):

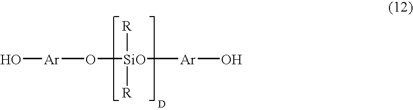

wherein R, Ar, and D are as described above. Compounds of formula (12) may be obtained by the reaction of a dihydroxyarylene compound with, for example, an alpha, omega-bisacetoxypolydiorganosiloxane under phase transfer conditions.

In another embodiment, polydiorganosiloxane blocks comprise units of formula (13):

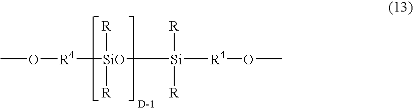

wherein R and D are as described above, and each occurrence of R⁴ is independently a divalent C₁-C₃₀ alkylene, and wherein the polymerized polysiloxane unit is the reaction residue of its corresponding dihydroxy compound. In a specific embodiment, the polydiorganosiloxane blocks are provided by repeating structural units of formula (14):

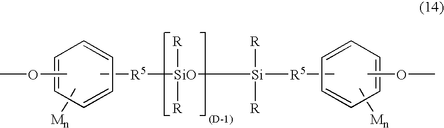

wherein R and D are as defined above. Each R⁵ in formula (14) is independently a divalent C₂-C₈ aliphatic group. Each M in formula (14) may be the same or different, and may be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ arylalkyl, C₇-C₁₂ arylalkoxy, C₇-C₁₂ alkylaryl, or C₇-C₁₂ alkylaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R⁵ is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R⁵ is a divalent C₁-C₃ aliphatic group, and R is methyl.

Units of formula (14) may be derived from the corresponding dihydroxy polydiorganosiloxane (15):

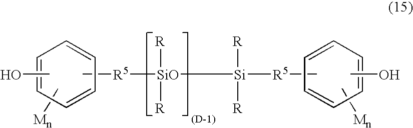

wherein R, D, M, R⁵, and n are as described above. Such dihydroxy polysiloxanes can be made by effecting a platinum catalyzed addition between a siloxane hydride of formula (16):

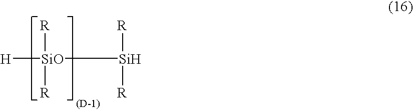

wherein R and D are as previously defined, and an aliphatically unsaturated monohydric phenol. Useful aliphatically unsaturated monohydric phenols included, for example, eugenol, 2-allylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing may also be used.

The polycarbonate polymer of the polyestercarbonate composition may be selected from any of the polycarbonate copolymers described above. However, it becomes increasingly difficult to enhance fire retardance properties as the level of alkyl groups in those copolymers increases. In specific embodiments, the polycarbonate polymer is a polycarbonate homopolymer.

In specific embodiments, the dihydroxy compound has the structure of Formula (I):

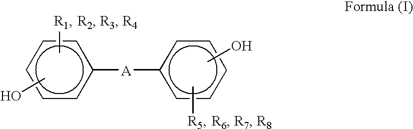

wherein R₁ through R₈ are each independently selected from hydrogen, halogen, nitro, cyano, C₁-C₂₀ alkyl, C₄-C₂₀ cycloalkyl, and C₆-C₂₀ aryl; and A is selected from a bond,
—O—, —S—, —SO₂—, C₁-C₁₂ alkyl, C₆-C₂₀ aromatic, and C₆-C₂₀ cycloaliphatic.

In specific embodiments, the dihydroxy compound of Formula (I) is 2,2-bis(4-hydroxyphenyl)propane (i.e. bisphenol-A or BPA). Other illustrative compounds of Formula (I) include:
2,2-bis(3-bromo-4-hydroxyphenyl)propane;
2,2-bis(4-hydroxy-3-methylphenyl)propane;
2,2-bis(4-hydroxy-3-isopropylphenyl)propane;
2,2-bis(3-t-butyl-4-hydroxyphenyl)propane;
2,2-bis(3-phenyl-4-hydroxyphenyl)propane;
2,2-bis(3,5-dichloro-4-hydroxyphenyl)propane;
1,1-bis(4-hydroxyphenyl)cyclohexane;
1,1-bis(3-chloro-4-hydroxyphenyl)-3,3,5-trimethylcyclohexane;
4,4′dihydroxy-1,1-biphenyl;
4,4′-dihydroxy-3,3′-dimethyl-1,1-biphenyl;
4,4′-dihydroxy-3,3′-dioctyl-1,1-biphenyl;
4,4′-dihydroxydiphenylether;
4,4′-dihydroxydiphenylthioether; and
1,3-bis(2-(4-hydroxyphenyl)-2-propyl)benzene.

The polyestercarbonate polymer further comprises a polyester unit. The polyester unit is derived from the reaction of isophthalic acid, terephthalic acid, and resorcinol (also known as an ITR unit). The polyester unit has the general structure of Formula (II):

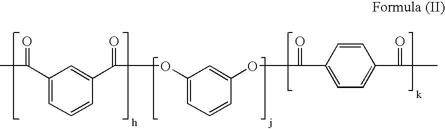

where h corresponds to the molar percentage of the isophthalate, j corresponds to the molar percentage of the resorcinol, and k corresponds to the molar percentage of the terephthalate; h, j, and k adding to 100 mole percent of the polyester unit. In some embodiments, the ratio of isophthalate to terephthalate (h:k) is from about 0.2 to about 4.0. In further embodiments, the ratio h:k is from about 0.4 to about 2.5 or from about 0.67 to about 1.5.

The polyester unit may also be represented by the general structure of Formula (III):

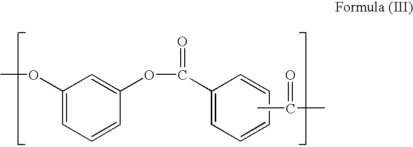

The polyestercarbonate polymer formed from the polycarbonate unit and the polyester unit may be represented by the general structure of Formula (IV):

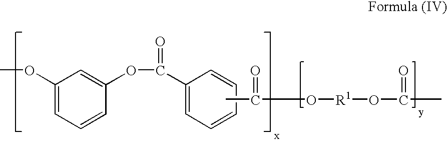

where x is the molar percentage of the polyester unit and y is the molar percentage of the polycarbonate unit, x and y adding up to 100 mole percent of the polyestercarbonate; and R¹ is as defined above with respect to Formula (1). Such polyestercarbonate polymers are available from General Electric Company with various ratios of polyester units to polycarbonate units, or x:y. Formula (IV) shows only the two units and their molar percentages; it should not be construed as showing specific linkages within the polyestercarbonate polymer.

In particular embodiments, the polyestercarbonate polymer contains at least 40 mole percent of the polyester unit. In other words, the ratio of x:y is at least 40:60. In specific embodiments, the polyestercarbonate polymer contains at least 75 mole percent of the polyester unit, based on the total number of moles of polycarbonate units and polyester units.

In embodiments, the polyester units are substantially free of anhydride linkages. “Substantially free of anhydride linkages” means that the polyestercarbonate shows a decrease in molecular weight of less than 10% upon heating said polyestercarbonate at a temperature of about 280° C. to 290° C. for five minutes. In more particular embodiments, the polyestercarbonate shows a decrease of molecular weight of less than 5%.

In various embodiments of Formula IV, the polyester units have a degree of polymerization (DP) of at least 5. In further embodiments, the polyester units have a DP of at least 50, at least 100, and in other embodiments from about 30 to about 150. The DP of the polycarbonate units is at least 1. In further embodiments, the polycarbonate units have a DP of at least 3, at least 10, and in other embodiments from about 20 to about 200. Within the context of the present disclosure, the architecture of the polyester and polycarbonate units may vary within the polycarbonate.

The polycarbonate polymer and the polyestercarbonate polymer are different from each other. In specific embodiments, the polycarbonate polymer is a polycarbonate homopolymer.

The polyestercarbonate and polycarbonate polymers together total 100 parts of resin by weight. The polyestercarbonate polymer may comprise from about 14 to about 90 parts per hundred parts resin (phr), and the polycarbonate polymer may comprise the remaining portion of the resin. In other words, the weight ratio of polyestercarbonate polymer to polycarbonate polymer is from 14:86 to about 90:10.

The polyestercarbonate and polycarbonate polymers are combined so that the resulting composition contains at least 8 mole percent of polyester units, based on the total number of moles of monomers in the polycarbonate polymer, polycarbonate units, and polyester units. In specific embodiments, the composition contains at least 12 mole percent of polyester units.

The fire-resistant composition further comprises a salt based flame retardant. Useful salt-based flame retardants include alkali metal or alkaline earth metal salts of inorganic protonic acids and organic Bronsted acids comprising at least one carbon atom. These salts should not contain chlorine and/or bromine. Preferably, the salt based flame retardants are sulfonates. In specific embodiments, the salt based flame retardant is from the group consisting of potassium diphenylsulfon-3-sulfonate (KSS), potassium perfluorobutane sulfonate (Rimar salt), and combinations comprising at least one of the foregoing.

The salt based flame retardant(s) are present in quantities effective to achieve a UL94 V0 flame resistant rating. In generally, the salt based flame retardant is present in the amount of from about 0.05 parts to about 0.15 part per hundred parts resin.

The fire-resistant composition may further comprise an anti-drip agent. Anti-drip agents may be, for example, a fibril forming or non-fibril forming fluoropolymer such as polytetrafluoroethylene (PTFE). The anti-drip agent may be encapsulated by a rigid copolymer as described above, for example styrene-acrylonitrile copolymer (SAN). PTFE encapsulated in SAN is known as TSAN. Encapsulated fluoropolymers may be made by polymerizing the encapsulating polymer in the presence of the fluoropolymer, for example an aqueous dispersion. TSAN may provide significant advantages over PTFE, in that TSAN may be more readily dispersed in the composition. A useful TSAN may comprise, for example, 50 wt % PTFE and 50 wt % SAN, based on the total weight of the encapsulated fluoropolymer. The SAN may comprise, for example, 75 wt % styrene and 25 wt % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer. Anti-drip agents can be used in amounts of from about 0.1 to about 5 parts per hundred parts resin. In particular embodiments, the anti-drip agent is present at about 0.5 phr.

The fire-resistant composition may further comprise a colorant. In particular embodiments, the colorant is titanium dioxide, which imparts a white color to the fire-resistant composition. In embodiments, the colorant is present in the fire-resistant composition in the amount of from zero to about 12 parts per hundred parts resin.

The fire-resistant composition may further include various additives ordinarily incorporated in resin compositions of this type. Such additives include, for example, fillers or reinforcing agents; heat stabilizers; antioxidants; light stabilizers; plasticizers; antistatic agents; and blowing agents. Examples of fillers or reinforcing agents include glass fibers, glass beads, carbon fibers, silica, talc and calcium carbonate. Examples of heat stabilizers include triphenyl phosphite, tris-(2,6-dimethylphenyl)phosphite, tris-(2,4-di-t-butyl-phenyl) phosphite, tris-(mixed mono- and di-nonylphenyl)phosphite, dimethylbenzene phosphonate and trimethyl phosphate. Examples of antioxidants include octadecyl-3-(3,5-di-tert-butyl-4-hydroxyphenyl)propionate, and pentaerythrityl-tetrakis[3-(3,5-di-tert-butyl-4-hydroxyphenyl)propionate]. Examples of light stabilizers include 2-(2-hydroxy-5-methylphenyl)benzotriazole, 2-(2-hydroxy-5-tert-octylphenyl)-benzotriazole and 2-hydroxy-4-n-octoxy benzophenone. Examples of plasticizers include dioctyl-4,5-epoxy-hexahydrophthalate, tris-(octoxycarbonylethyl)isocyanurate, tristearin and epoxidized soybean oil. Examples of antistatic agents include glycerol monostearate, sodium stearyl sulfonate, and sodium dodecylbenzenesulfonate. Examples of other resins include but are not limited to polypropylene, polystyrene, polymethyl methacrylate, and polyphenylene oxide.

UV absorbers may be used. Exemplary UV absorbers include hydroxybenzophenones; hydroxybenzotriazoles; hydroxybenzotriazines; cyanoacrylates; oxanilides; benzoxazinones; nano-size inorganic materials such as titanium oxide, cerium oxide, and zinc oxide, all with particle size less than 100 nanometers; or the like, or combinations comprising at least one of the foregoing UV absorbers.

Plasticizers, lubricants, and/or mold release agents additives may also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like.

Combinations of any of the foregoing additives may be used. Such additives may be mixed at a suitable time during the mixing of the components for forming the composition.

The fire-resistant polyestercarbonate composition may be made by intimately mixing the polycarbonate polymer, polyestercarbonate polymer, salt based flame retardant, and other additives either in solution or in melt, using any known mixing method. Typically, there are two distinct mixing steps: a premixing step and a melt mixing step. In the premixing step, the ingredients are mixed together. This premixing step is typically performed using a tumbler mixer or a ribbon blender. However, if desired, the premix may be manufactured using a high shear mixer such as a Henschel mixer or similar high intensity device. The premixing step must be followed by a melt mixing step where the premix is melted and mixed again as a melt. Alternatively, it is possible to eliminate the premixing step, and simply add the raw materials directly into the feed section of a melt mixing device (such as an extruder) via separate feed systems. In the melt mixing step, the ingredients are typically melt kneaded in a single screw or twin screw extruder, and extruded as pellets. Alternatively, one or more of the components may be incorporated into the polymers by feeding directly into the extruder at the throat and/or downstream through a sidestuffer. Additives may also be compounded into a masterbatch with a desired polymeric resin and fed into the extruder. The extruder is generally operated at a temperature higher than that necessary to cause the composition to flow. The extrudate is immediately quenched in a water batch and pelletized. The pellets may be one-fourth inch long or less as desired. Such pellets may be used for subsequent molding, shaping, or forming. Articles may be molded from the polyestercarbonate composition by a variety of means such as injection molding, extrusion, rotational molding, blow molding and thermoforming. In a specific embodiment, molding is done by injection molding.

The resulting fire-resistant polyestercarbonate composition has several desirable properties. It has UL94 V0 performance at gauges as low as 0.71 millimeters while maintaining other mechanical properties. By comparison, a normal polycarbonate composition can only maintain V0 performance at 1.1 millimeter thickness. The composition has higher ultraviolet resistance as well. It may have a melt flow rate of greater than 18 cc/10 minutes according to ASTM D1238, especially when the polyestercarbonate polymer contains at least 40 mole percent of the polyester unit. A composition which has both high flame retardance and high flow rate is especially desirable.

It was surprisingly found that the fire resistance of the final composition increased with the ITR content of the polyestercarbonate composition. Polyestercarbonates having ITR polyester units are known to have good weathering properties, such as being resistant to photodegradation, scratching, and attack by solvents. However, these properties generally do not relate to flame retardance capability. The literature on polyestercarbonates based on bisphenol-A did not suggest any improvement in fire retardance capability over polycarbonates either. Achieving a composition that had V0 performance at gauges lower than commercially available was thus unexpected. Even more surprising was the fact that the distribution of the ITR content within the composition affected the fire resistance. It was found that higher ITR content in the polyestercarbonate polymer increased fire resistance, even if the overall ITR content in the composition was the same. This also allowed better maintenance of other mechanical properties, such as the melt volume rate (MVR).

In further specific embodiments, the composition contains at least 8 mole percent of polyester units, based on the total moles of polycarbonate monomers, polycarbonate units, and polyester units; and the polyestercarbonate polymer contains at least 40 mole percent of polyester units, based on the total moles of polycarbonate units and polyester units. In other specific embodiments, the composition contains at least 8 mole percent of polyester units and the polyestercarbonate polymer contains at least 75 mole percent of polyester units. In other specific embodiments, the composition contains at least 12 mole percent of polyester units and the polyestercarbonate polymer contains at least 75 mole percent of polyester units.

The following examples are provided to illustrate the compositions and methods of the present disclosure. The examples are merely illustrative and are not intended to limit devices made in accordance with the disclosure to the materials, conditions, or process parameters set forth therein.

### EXAMPLES

### Example 1

A polyestercarbonate designated ITR9010 had about 82.5 mole % polyester units. The ITR9010 resin was prepared in the following manner. Other ITR resins were prepared in similar manners.

Oligomer Synthesis:

To a 200 gallon (750 L) glass lined reactor equipped with condenser, agitator, pH probe, caustic inlet, and recirculation loops were added methylene chloride (281 L), triethylamine (0.74 kg, 7.31 mol), an aqueous solution of resorcinol (89 kg solution, 44.9% w/w, 362 mol), and a methylene chloride solution of p-cumylphenol (10.8 kg, 33% w/w, 16.7 mol, adjustable to achieve a desired MVR target). A molten mixture of isophthaloyl chloride and terephthaloyl chloride isomers (DAC, 1:1 molar ratio of isomers, 66.3 kg, 326 mol, 4.3 kg/min) was added to the reaction vessel while simultaneously adding sodium hydroxide (50% w/w sodium hydroxide solution, 0.7 NaOH/DAC weight ratio or 1.77 NaOH/DAC molar ratio) as a separate stream over a 15 min period. The pH decreased from pH 7-8 to pH ˜4. After completion of DAC addition, sodium hydroxide was added to raise the pH to 7-8.5. The reactor contents were stirred for 10 min.

Phosgenation:

To a 300 gal (1,125 L) glass-lined reactor equipped with condenser, agitator, pH probe, phosgene inlet, caustic inlet, and recirculation loop were charged bisphenol-A (6.5 kg, 28.2 mol), sodium gluconate (0.16 kg), water (132 L) and methylene chloride (154 L). The entire oligomer solution from the oligomer reactor was transferred to the phosgenation reactor by rinsing the oligomer reactor and its condensers with 22.5 L of methylene chloride. Phosgene (18 kg total, 183.4 mol) was co-fed with sodium hydroxide (50% w/w) to the reactor under ratio-pH control. The phosgene addition rate was maintained at 91 kg/hr for the initial 80% of phosgene addition (14.5 kg) and decreased to 68 kg/hr for the remaining 20% of phosgene addition (3.6 kg). The sodium hydroxide/phosgene ratio profile of the batch started with a NaOH/phosgene weight ratio of 2.30 which was changed to 2.20 at 10% of phosgene addition, 2.00 at 50% of phosgene addition, and 2.50 at 70% of phosgene addition. The targeted pH for the phosgenation reaction was ˜8 for the initial 70% of phosgenation and 8.5 for the remaining 30% of phosgenation. The batch was sampled for molecular weight analyses and then re-phosgenated (4.5 kg phosgene, 45.9 mol, pH target 9.0). The pH was raised to about 9 with 50% w/w sodium hydroxide and the batch was transferred to a centrifuge feed tank, where hydrochloric acid was added to lower the pH of the batch to pH ˜8. The resultant solution of polymer in methylene chloride was purified by acid wash and subsequent water washes via centrifugation. The final polymer was isolated by steam precipitation and dried under a stream of hot nitrogen.

### Example 2

Flammability tests were performed following the procedure of Underwriter's Laboratory Bulletin 94 entitled “Tests for Flammability of Plastic Materials, UL94”, which is incorporated herein by reference. According to this procedure, the materials were classified as either UL94 V0, UL94 V1 or UL94 V2 on the basis of the test results obtained for five samples. The procedure and criteria for each of these flammability classifications according to UL94, are, briefly, as follows:

Procedure: A total of 10 specimens (2 sets of 5) are tested per thickness. Five of each thickness are tested after conditioning for 48 hours at 23° C., 50% relative humidity. The other five of each thickness are tested after conditioning for seven days at 70° C. The bar is mounted with the long axis vertical for flammability testing. The specimen is supported such that its lower end is 9.5 mm above the Bunsen burner tube. A blue 19 mm high flame is applied to the center of the lower edge of the specimen for 10 seconds. The time until the flaming of the bar ceases is recorded. If burning ceases, the flame is re-applied for an additional 10 seconds. Again, the time until the flaming of the bar ceases is recorded. If the specimen drips particles, these shall be allowed to fall onto a layer of untreated surgical cotton placed 305 mm below the specimen.

Criteria for flammability classifications according to UL94:

| | V0 | V1 | V2 |
|---|---|---|---|
| Individual flame time (sec) | ≦10 | ≦30 | ≦30 |
| Total flame time of 5 specimens (sec) | ≦50 | ≦250 | ≦250 |
| Glowing time of individual specimens (sec) | ≦30 | ≦60 | ≦60 |
| Particles ignite cotton? | No | No | Yes |

The flame out times from two sets of ten bars (20 bars total, 10 per thickness) were used to generate a p(FTP) value. The p(FTP) value is a statistical evaluation of the robustness of UL94 V0 performance. When the p(FTP) value is one or nearly one, the material is expected to consistently meet the UL94 V0 rating.

Mechanical properties were measured according to the following ASTM standards:

| | | Testing | |
|---|---|---|---|
| | Standards | Conditions | Specimen Type |
| Melt Volume Rate | ASTM D 1238 | 300° C., | |
| | | 1.2 Kg | |
| Tensile Modulus | ASTM D 638 | 50 mm/min | 57 * 13 * 3.18 * |
| | | | 176 |
| Flexural Modulus | ASTM D 790 | 1.3 mm/min | 127 * 12.7 * 3.18 |
| Notched Izod | ASTM D 256 | 23° C. | 63.5 * 12.7 * 3.18 |
| Impact | | | |
| Heat Deflection | ASTM D 648 | 1.8 MPa | 3.2 mm thickness |
| Temperature | | | |

Table 1 shows the composition and performances of seven control compositions C1-C7 and eight exemplary compositions E1-E8. Each composition was made using the materials listed in Table 1. The amounts listed are parts per hundred parts resin. The ingredients were pre-blended, then extruded and molded under normal processing conditions.

The ITR resins were polyestercarbonate polymers containing various amounts of polyester units. The ITR9010 resin contained about 82.5 mole percent ITR units; the ITR4060 resin contained about 42 mole percent ITR units; and the ITR2080 resin contained about 19 mole percent ITR units. The overall ITR content of the composition was listed in the row entitled “Overall ITR.” The polyestercarbonate and polycarbonate polymers together totaled one hundred parts resin.

The low flow PC was a low flow Bisphenol-A polycarbonate homopolymer with a target molecular weight of 29,900 (based on GPC using polycarbonate standards). The high flow PC was a high flow Bisphenol-A polycarbonate homopolymer with a target molecular weight of 21,900 (based on GPC using polycarbonate standards). Pentaerythritol tetrastearate (PETS) was used as a mold release agent. Stabilizer 1 was cycloaliphatic epoxy resin and Stabilizer 2 was phosphonous acid ester (PEPQ powder). Rimar salt and TSAN were added as fire retardant and anti-drip agent, respectively.

The UL94 V0 performance was tested at three different thicknesses, 0.83 mm, 0.80 mm and 0.75 mm, although not all samples were tested at all thicknesses. The results are shown for both thicknesses at both testing conditions.

TABLE 1

| Description | Unit | C1 | C2 | C3 | C4 | C5 | C6 | C7 |
|---|---|---|---|---|---|---|---|---|
| ITR9010 resin | phr | | | | | | | |
| ITR4060 resin | phr | | | | | | | 10 |
| ITR2080 resin | phr | | 10 | 20 | 40 | 60 | 80 | |
| High flow PC | phr | 80 | 90 | 80 | 60 | 40 | 20 | 90 |
| Low flow PC | phr | 20 | | | | | | |
| PETS | phr | 0.3 | 0.3 | 0.3 | 0.3 | 0.3 | 0.3 | 0.3 |
| Stabilizer 1 | phr | 0.03 | 0.03 | 0.03 | 0.03 | 0.03 | 0.03 | 0.03 |
| Stabilizer 2 | phr | 0.06 | 0.06 | 0.06 | 0.06 | 0.06 | 0.06 | 0.06 |
| Rimar | phr | 0.06 | 0.06 | 0.06 | 0.06 | 0.06 | 0.06 | 0.06 |
| TSAN | phr | 0.5 | 0.5 | 0.5 | 0.5 | 0.5 | 0.5 | 0.5 |
| Overall ITR | mol % | 0 | 1.9 | 3.8 | 7.6 | 11.4 | 15.2 | 4.2 |
| MVR | cc/10 min | 19.1 | 27.5 | 24.2 | 21 | 17.4 | 14.7 | 24.3 |
| HDT | ° C. | 122 | 120 | 118 | 118 | 117 | 117 | 121 |
| Notched Izod Impact | J/m | 754 | 763 | 737 | 691 | 768 | 810 | 721 |
| Tensile Modulus | MPa | 2243 | 2320 | 2328 | 2320 | 2320 | 2337 | 2315 |
| Flexural Modulus | MPa | 2210 | 2220 | 2180 | 2180 | 2150 | 2250 | 2240 |
| V0 @0.80 mm (23° C., 48 hr) | FOT 5 (sec) | 57.7 | 31.85 | 31.25 | 35 | 40.3 | 43.8 | 30.25 |
| V0 @0.80 mm (23° C., 48 hr) | drops | 8/10 | 10/10 | 10/10 | 3/10 | 3/10 | 3/10 | 1/10 |
| V0 @0.80 mm (23° C., 48 hr) | Pass/Fail | Fail | Fail | Fail | Fail | Fail | Fail | Fail |

| Description | Unit | E1 | E2 | E3 | E4 | E5 | E6 | E7 | E8 |
|---|---|---|---|---|---|---|---|---|---|
| ITR9010 resin | phr | | | | | 20 | 40 | 60 | 80 |
| ITR4060 resin | phr | 20 | 40 | 60 | 80 | | | | |
| ITR2080 resin | phr | | | | | | | | |
| High flow PC | phr | 80 | 60 | 40 | 20 | 80 | 60 | 40 | 20 |
| Low flow PC | phr | | | | | | | | |
| PETS | phr | 0.3 | 0.3 | 0.3 | 0.3 | 0.3 | 0.3 | 0.3 | 0.3 |
| Stabilizer 1 | phr | 0.03 | 0.03 | 0.03 | 0.03 | 0.03 | 0.03 | 0.03 | 0.03 |
| Stabilizer 2 | phr | 0.06 | 0.06 | 0.06 | 0.06 | 0.06 | 0.06 | 0.06 | 0.06 |
| Rimar | phr | 0.06 | 0.06 | 0.06 | 0.06 | 0.06 | 0.06 | 0.06 | 0.06 |
| TSAN | phr | 0.5 | 0.5 | 0.5 | 0.5 | 0.5 | 0.5 | 0.5 | 0.5 |
| Overall ITR | mol % | 8.4 | 16.8 | 25.2 | 33.6 | 16.5 | 33 | 49.5 | 66 |
| MVR | cc/10 min | 22.5 | 18.4 | 14.9 | 11 | 20.7 | 18 | 14.1 | 10.9 |
| HDT | ° C. | 121 | 119 | 118 | 117 | 120 | 117 | 116 | 115 |
| Notched Izod Impact | J/m | 565 | 700 | 787 | 658 | 746 | 674 | 251 | 199 |
| Tensile Modulus | MPa | 2319 | 2330 | 2341 | 2349 | 2248 | 2302 | 2306 | 2336 |
| Flexural Modulus | MPa | 2260 | 2260 | 2280 | 2290 | 2130 | 2150 | 2190 | 2190 |
| V0 @0.83 mm (23° C., 48 hr) | FOT 5 (sec) | | | | | 20.25 | 17.95 | 13.55 | 14.6 |
| V0 @0.83 mm (23° C., 48 hr) | Drops | | | | | 0/10 | 0/10 | 0/10 | 0/10 |
| V0 @0.83 mm (23° C., 48 hr) | Pass/Fail | | | | | Pass | Pass | Pass | Pass |
| V0 @0.83 mm (70° C., 168 hr) | FOT 5 (sec) | | | | | 22.9 | 17.15 | 18.35 | 14.65 |
| V0 @0.83 mm (70° C., 168 hr) | Drops | | | | | 0/10 | 0/10 | 0/10 | 0/10 |
| V0 @0.83 mm (70° C., 168 hr) | Pass/Fail | | | | | Pass | Pass | Pass | Pass |
| V0 @0.80 mm (23° C., 48 hr) | FOT 5 (sec) | 27.6 | 27.75 | 21.15 | 21.5 | | | | |
| V0 @0.80 mm (23° C., 48 hr) | Drops | 0/10 | 0/10 | 0/10 | 0/10 | | | | |
| V0 @0.80 mm (23° C., 48 hr) | Pass/Fail | Pass | Pass | Pass | Pass | | | | |
| V0 @0.75 mm (23° C., 48 hr) | FOT 5 (sec) | | | | | 16.15 | 17.75 | 17.75 | 15 |
| V0 @0.75 mm (23° C., 48 hr) | Drops | | | | | 0/10 | 0/10 | 0/10 | 0/10 |
| V0 @0.75 mm (23° C., 48 hr) | Pass/Fail | | | | | Pass | Pass | Pass | Pass |
| V0 @0.75 mm (70° C., 168 hr) | FOT 5 (sec) | | | | | 17.2 | 13.7 | 15.5 | 16.3 |
| V0 @0.75 mm (70° C., 168 hr) | Drops | | | | | 0/10 | 0/10 | 0/10 | 0/10 |
| V0 @0.75 mm (70° C., 168 hr) | Pass/Fail | | | | | Pass | Pass | Pass | Pass |

The results showed that E5-E8 had V0 performance at gauges as low as 0.75 mm, whereas the control compositions could not achieve V0 performance at 0.80 mm. The tensile and flexural moduli did not change significantly. The HDT decreased slightly as the ITR content increased, but was still comparable to conventional polycarbonate. For example, Idemitsu AC3010 polycarbonate claims V0 performance at 0.75 mm, but has a HDT of only 100° C., or 15% lower than the instant polyestercarbonate compositions. In addition, the AC301 0 has lower impact strength. E5 and E6 in particular had a high MFR (greater than 18 cc/10 min) and polycarbonate-like HDT and NII.

The results also showed that compositions where the polyestercarbonate polymer contained greater ITR content performed better. In particular, comparing E2 to E5, E5 had higher MVR and NII even though their overall ITR content was similar. Comparing E4 to E6 also showed the same results. This was a surprising and unexpected result.

Comparing E1 to C6 also supported this conclusion. C6 contained 15.2 mol % ITR content overall, but used ITR2080 resin. In contrast, E1 contained 8.4 mol % ITR content overall, but used ITR4060, which had greater ITR content. The greater concentration of ITR within the polyestercarbonate gave better fire retardance results, even though the overall ITR content was lower.

### Example 3

Four more exemplary compositions E9-E12 were made. Table 2 lists their compositions and selected physical properties.

TABLE 2

| Description | Unit | E9 | E10 | E11 | E12 |
|---|---|---|---|---|---|
| ITR9010 resin | phr | 14 | 16 | 18 | 20 |
| High flow PC | phr | 86 | 84 | 82 | 80 |
| PETS | phr | 0.3 | 0.3 | 0.3 | 0.3 |
| Stabilizer 1 | phr | 0.03 | 0.03 | 0.03 | 0.03 |
| Stabilizer 2 | phr | 0.06 | 0.06 | 0.06 | 0.06 |
| Rimar | phr | 0.06 | 0.06 | 0.06 | 0.06 |
| TSAN | phr | 0.5 | 0.5 | 0.5 | 0.5 |
| Overall ITR | mol % | 11.6 | 13.2 | 14.9 | 16.5 |
| MVR | cc/10 min | 21.5 | 20.1 | 19.8 | 20.6 |
| V0 @0.71 mm (23° C., 48 hr) | FOT 5 (s) | 36.1 | 19.7 | 18.1 | 13.7 |
| V0 @0.71 mm (23° C., 48 hr) | drops | 0/10 | 0/10 | 0/10 | 0/10 |
| V0 @0.71 mm (23° C., 48 hr) | Pass/Fail | Pass | Pass | Pass | Pass |

The results showed that the polyestercarbonate compositions of the present disclosure could attain UL94 V0 performance at thicknesses of 0.71 mm. Also, a comparison of E9-E12 with C5 and C6 again supported the surprising conclusion that a higher concentration of ITR in the polyestercarbonate conferred better fire retardance properties, even though the overall ITR content of the compositions was about the same.

### Example 3

A control composition C8 and an exemplary composition E13 were made. The low flow PC was a low flow Bisphenol-A polycarbonate with a target molecular weight of 29,900. Both compositions also included 12 phr of TiO₂.

The two were then tested for color stability upon UV exposure by the QUVB method complying with ASTM G154. The delta YI value was calculated at each exposure time by measuring the yellowness index (YI) after exposure and subtracting from it the initial YI before exposure. They were also tested for their fire retardance properties. Table 3 lists their compositions and the results after various periods of exposure.

TABLE 3

| Description | Unit | C8 | E13 |
|---|---|---|---|
| ITR9010 resin | phr | | 20 |
| High flow PC | phr | 90 | 80 |
| Low flow PC | phr | 10 | |
| Mold release | phr | 0.35 | 0.3 |
| Rimar | phr | 0.09 | 0.06 |
| TSAN | phr | 0.5 | 0.5 |
| TiO₂ | phr | 12 | 12 |
| V0@1.4 mm (23° C., 48 hr) | FOT 5 (sec) | 59.6 | 15.7 |
| V0@1.4 mm (23° C., 48 hr) | drops | 0/10 | 0/10 |
| V0@1.4 mm (23° C., 48 hr) | Pass/Fail | Fail | Pass |
| QUVB exposure time (hrs) | | | |
| 50 | delta YI | 8.4 | 10.4 |
| 100 | delta YI | 15.4 | 15.8 |
| 150 | delta YI | 23.2 | 19.1 |
| 200 | delta YI | 24.3 | 19.4 |
| 300 | delta YI | 29.6 | 19.3 |

After 300 hours of UVB exposure, C9 had a delta YI of 29.6 compared to a delta YI of 19.3 for E9. This indicated that E9 had better UV resistance.

The polyestercarbonate compositions of the present disclosure have been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A fire-resistant polyestercarbonate composition comprising:
a salt based flame retardant;
a polycarbonate polymer comprising at least one monomer; and
a polyestercarbonate polymer comprising a polycarbonate unit and a polyester unit, the polyester unit derived from the reaction of isophthalic acid, terephthalic acid, and resorcinol, and represented by the structure of Formula (IV): 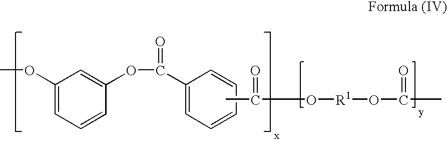
where x is the molar percentage of the polyester unit and y is the molar percentage of the polycarbonate unit, x and y adding up to 100 mole percent of the polyestercarbonate polymer;
wherein the polycarbonate polymer differs from the polyestercarbonate polymer;
wherein the composition contains at least 8 mole percent of polyester units, based on the total moles of the at least one monomer, polycarbonate unit, and polyester unit; and
wherein the polyestercarbonate polymer contains at least 40 mole percent of the polyester unit, based on the total moles of polycarbonate units and polyester units.

2. The composition of claim 1, wherein the composition contains at least 12 mole percent of the polyester unit.

3. The composition of claim 1, wherein the polycarbonate polymer is a polycarbonate homopolymer.

4. The composition of claim 1, wherein the salt based flame retardant is a perfluorobutane sulfonate salt.

5. The composition of claim 1, wherein the salt based flame retardant is present in the amount of from about 0.05 parts to about 0.15 parts per hundred parts resin.

6. The composition of claim 1, wherein the composition has a melt volume rate of from about 5 cc/10 minutes to about 25 cc/10 minutes, according to ASTM D1238.

7. The composition of claim 1, wherein the composition has a heat deflection temperature of at least 114° C., according to ASTM D648.

8. The composition of claim 1, further comprising an anti-drip agent.

9. The composition of claim 8, wherein the anti-drip agent is present in the amount of about 0.1 to about 5 parts per hundred parts resin.

10. The composition of claim 1, further comprising a colorant.

11. The composition of claim 10, wherein the colorant is present in the amount of zero to about 12 parts per hundred parts resin.

12. The composition of claim 10, wherein the colorant is titanium dioxide (TiO₂).

13. The composition of claim 1, wherein the composition can attain V0 performance according to UL94 at a thickness of 0.71 millimeters.

14. A fire-resistant polyestercarbonate composition comprising:
a salt based flame retardant;
an anti-drip agent;
a polycarbonate polymer comprising at least one monomer; and
a polyestercarbonate polymer comprising a polycarbonate unit and a polyester unit, the polyester unit derived from the reaction of isophthalic acid, terephthalic acid, and resorcinol, and represented by the structure of Formula (IV): 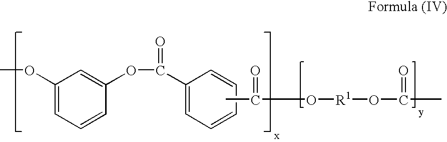
where x is the molar percentage of the polyester unit and y is the molar percentage of the polycarbonate unit, x and y adding up to 100 mole percent of the polyestercarbonate polymer;
wherein the polycarbonate polymer differs from the polyestercarbonate polymer;
wherein the composition contains at least 8 mole percent of polyester units, based on the total moles of the at least one monomer, polycarbonate unit, and polyester unit; and
wherein the polyestercarbonate polymer contains at least 75 mole percent of the polyester unit, based on the total moles of polycarbonate units and polyester units.

15. The composition of claim 14, wherein the polycarbonate polymer is a polycarbonate homopolymer.

16. The composition of claim 14, further comprising titanium dioxide (TiO₂) in the amount of about 12 parts per hundred parts resin.

17. The composition of claim 14, wherein the weight ratio of polyestercarbonate polymer to polycarbonate homopolymer is from about 14:86 to about 90:10.

18. The composition of claim 14, wherein the composition can attain V0 performance according to UL94 at a thickness of 0.71 millimeters.

19. A fire-resistant polyestercarbonate composition comprising:
a salt based flame retardant;
an anti-drip agent;
a polyestercarbonate polymer comprising a polycarbonate unit and a polyester unit, the polyester unit derived from the reaction of isophthalic acid, terephthalic acid, and resorcinol, and represented by the structure of Formula (IV): 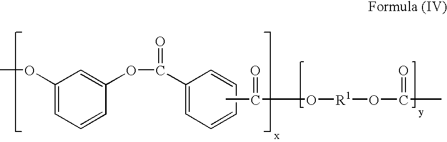
where x is the molar percentage of the polyester unit and y is the molar percentage of the polycarbonate unit, x and y adding up to 100 mole percent of the polyestercarbonate polymer; and
a polycarbonate homopolymer comprising at least one monomer;
wherein the composition contains at least 12 mole percent of polyester units, based on the total moles of the at least one monomer, polycarbonate unit, and polyester unit;
wherein the polyestercarbonate polymer contains at least 75 mole percent of the polyester unit, based on the total moles of polycarbonate units and polyester units; and
wherein the weight ratio of polyestercarbonate polymer to polycarbonate homopolymer is from about 14:86 to about 90:10.

20. The composition of claim 19, wherein the composition can attain V0 performance according to UL94 at a thickness of 0.71 millimeters.
